(19) United States
(12) Patent Application Publication
(10) Pub. No.: US 2008/0033772 A1
(43) Pub. Date: Feb. 7, 2008

(54) Information processing method, information processing apparatus and program

(75) Inventors: Kayo Endou, Kawasaki (JP); Akihisa Shouen, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/643,975

(22) Filed: Dec. 22, 2006

(30) Foreign Application Priority Data
Jul. 18, 2006 (JP) 2006-196083

(51) Int. Cl. G06F 17/50

(52) U.S. Cl. 705/7

(57) ABSTRACT

An information processing method in a system providing a service in response to a request, includes a demand forecasting step of forecasting a demand by means of a calculation according to a Monte Carlo method; an actual value comparing step of comparing the forecast value obtained from the demand forecasting step with an actual value to obtain a difference therebetween; and a coefficient revising step of revising a calculation coefficient used in the demand forecasting step in consideration of the difference.

### BACKGROUND OF THE INVENTION

1. Field of the Invention

The present invention relates to an information processing method, an information processing apparatus and a program, and, in particular, relates to an information processing method, an information processing apparatus and a program, configured for improving an accuracy of a demand forecast.

2. Description of the Related Art

A point of a product development in various technical fields is to bring high-performance products to a market as soon as possible. Recently, it is required to build a virtual-factory-like large-scale and high-performance processing environment. For this purpose, for example, a high-performance CAD environment for a vertical design of a product; a large-scale high-speed simulation environment for proving a performance of a product, an electric/mechanical CAD or an analyzing CAE environments for evaluating a product in an initial design stage, are advantageous.

In these high-performance product development environments, such a service providing system is required that, a service is not restricted in terms of providing time, location and scale, and also, high-speed processing in various applications is available. Specifically, it is advantageous to build a so-called ASP (application service provider) environment.

For this purpose, it is preferable that associating processing in a large-scale high-performance information processing resource environment, a collaboration environment in which speech communication processing from a remote location is available in such a manner, as close in operation and feeling as local operation, are achieved. Further, it is advantageous that such an environment is applied throughout a wide range, from a product development through disposal of, exceeding merely the product development field, for a PLM (product life cycle management) field or such.

Such a wide range of information associating processing may be not sufficiently achieved only from processing resource operation in a LAN (local area network) scale, such as an external network shown in FIG. 5. Accordingly, along with a wide spread of a utilization scale due to a request for a further complicatedness and higher efficiency of a development environment, utilization of the Internet or such, and thus, server concentration by means of sharing of resources for a wide area, tend to rapidly develop.

In the ASP operation environment in the related art, even if a possible shortage of the information processing resources is forecast based on a utilization plan of each user, an asset management may not be carried out effectively due to an occurrence of various troubles during regular business operation, a degradation in operation efficiency caused by a change in operating condition along with execution of various sorts of processing, an occurrence of doubtful asset due to a surplus asset, or such.

FIG. 5 diagrammatically shows such an ASP operation environment.

As shown, various bases A, B, C, . . . are associated by means of a communication network environment such as the Internet, or such, and various resources, i.e., LAN resources, CPU resources, memory resources, file resources, software resources', and so forth, may be shared.

In such an ASP system in which high-performance servers are concentrated in a center for carrying out processing, information processing resources are shared by many users. As a result, such a situation may occur that, when a data processing amount changes sharply, a surplus or a shortage of the processing resources occurs.

Especially, as the number of users increases, merely a little surplus in each user may result in a large surplus in the entirety. In order to achieve an efficient resource management, it is necessary to build an efficient operation structure considering past utilization experience, always improving a demand forecast accuracy, and avoiding a surplus in the resources as much as possible.

In this regard, various related arts have been proposed by Japanese Laid-Open Patent Applications Nos. 2002-99714 (patent document 1); 2005-293048 (patent document 2); 2003-58518 (patent document 3); and 2004-287801 (patent document 4).

Patent document 1 discloses a ‘business risk plan system building method and a utilization cost calculating method therefor’. In this art, a forecast of computer resources or utilization costs is carried out with the user of a Monte Carlo method. However, a forecast of utilization of a communication network, storage, software license and so forth, are not considered.

Patent document 2 discloses a ‘resource plan creating program’. In this art, a forecast for a data center resource is carried out. However, this document is silent for a forecast with the use of a Monte Carlo method for a medium term. Further, dynamic revising is neither disclosed nor suggested.

Patent document 3 discloses ‘a network system, a CPU resource provider, a client apparatus, processing service providing method and a program’. In this document, a configuration of applying a Monte Carlo method for CPU processing capability is disclosed. However, this document is silent for total service entirety for providing a network, a storage, a software license and so froth, as an ASP, and a revision reflecting experience information.

Patent document 4 discloses ‘an information processing system, an information processing apparatus, a distributed information processing method and a computer program’. In this art, dividing and management are carried out for respective ones of the number of available clusters. However, in this document, only hardware is disclosed, and the document is silent for software. Further, the document is silent for a forecast using a Monte Carlo method.

### SUMMARY OF THE INVENTION

The present invention has been devised in consideration of the above-mentioned situations, and an object of the present invention is to provide an information processing method and an information processing apparatus for effectively improving a demand forecast accuracy, and a program for causing a computer to execute the method.

According to the present invention, an information processing method for a system providing a service in response to a request, includes a demand forecasting step of forecasting a demand by means of a calculation according to a Monte Carlo method; an actual value comparing step of comparing the forecast value obtained from the demand forecasting step with an actual value to obtain a difference therebetween; and a coefficient revising step of revising a calculation coefficient used in the demand forecasting step in consideration of the difference.

In the demand forecast thus applying the Monte Carlo method, the calculation coefficient is appropriately revised in consideration of a difference from the actual value, and thus, it is possible to always provide a high-accuracy forecast result in line with the actual condition.

As a result, it is possible to achieve effective resource management in the above-mentioned ASP center for example, and thus, it is possible to improve the operation efficiency thereof.

### BRIEF DESCRIPTION OF THE DRAWINGS

Other objects and further features of the present invention will become more apparent from the following detailed description when read in conjunction with the accompanying drawings:

FIG. 1 shows a processing flow chart of basic processing of an information processing method according to an embodiment of the present invention;

FIG. 2 shows a processing flow chart of demand forecast processing of FIG. 1;

FIG. 3 illustrates comparison from an actual value in FIG. 1;

FIG. 4 shows a processing flow chart of a process for obtaining an average forecast demand amount in FIG. 2;

FIG. 5 illustrates a concept of information processing resources to which the embodiment of the present invention may be applied;

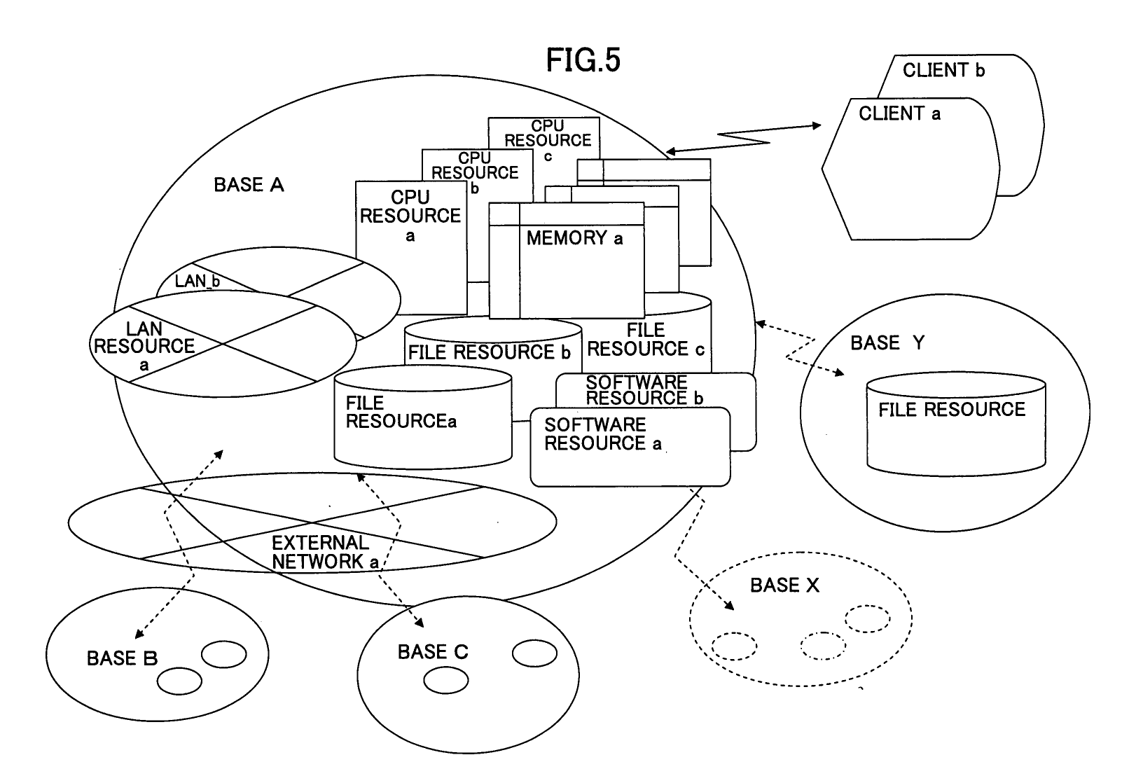

FIG. 6 illustrates a concept of a modified Monte Carlo method applicable to the embodiment of the present invention;

FIG. 7 shows a processing flow chart illustrating a general configuration of an information processing method in a variant embodiment of the present invention;

FIG. 8 shows a processing flow chart illustrating details of the information processing method in the embodiment of the present invention;

FIG. 9 shows a processing flow chart illustrating a detail configuration example of forecast data calculating processing;

FIG. 10 shows a processing flow chart illustrating a detail configuration example of processing of revising with the use of an actual value;

FIG. 11 illustrates a further specific configuration example of the embodiment of the present invention;

FIG. 12 illustrates details of experience obtaining processing of FIG. 11;

FIG. 13 illustrates details of log format converting processing of FIG. 11;

FIG. 14 illustrates details of file creating processing of FIG. 11;

FIG. 15 illustrates details of experience summing processing of FIG. 11; and

FIG. 16 shows a configuration example of a computer, for illustrating a case where the embodiment of the present invention is implemented with the computer.

### DETAILED DESCRIPTION OF THE PREFERRED EMBODIMENTS

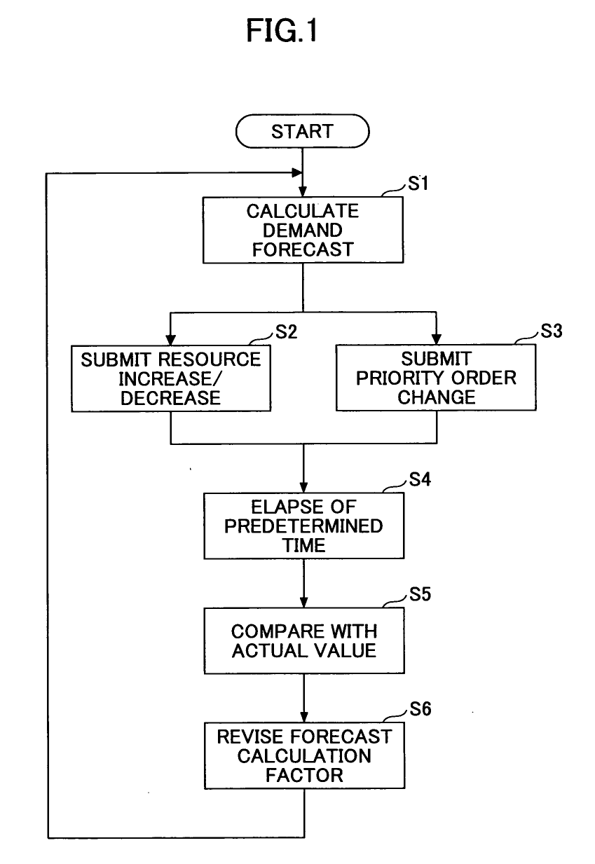

FIG. 1 shows a flow chart for a processing flow in a method of demand forecast and resource management based thereon, in one embodiment of the present invention.

This method is directed to making it possible to achieve an effective resource management by means of carrying out a demand forecast with a high accuracy in a system providing services in response to a use's request, with the use of various resources possessed by the above-mentioned ASP center or such, such as LAN resources, CPU resources, memory resources, file resources, software resources and so forth.

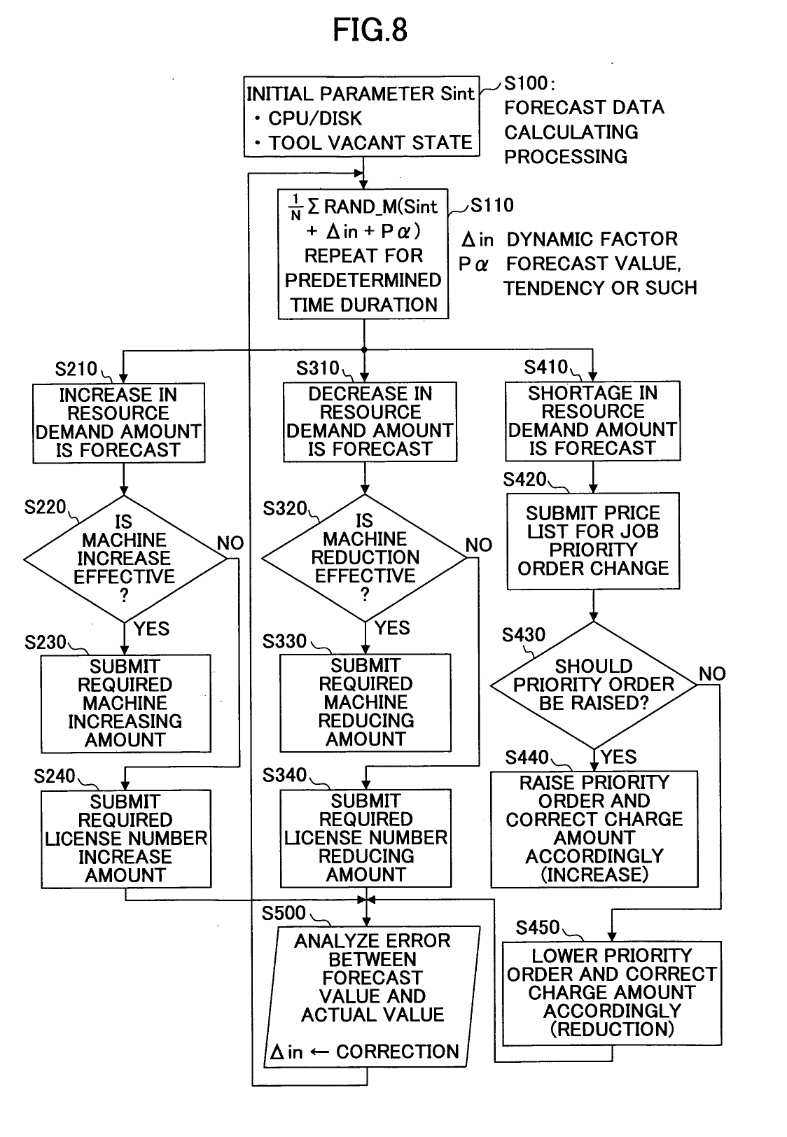

In FIG. 1, according to this method, first, a forecast of the demand for the user for the above-mentioned possessed resources is calculated (Step S1), an increase/decrease of the possessed resources is submitted or proposed (Step S2), or, an adjustment of each user's priority order (described later with reference to FIG. 8) is submitted or proposed (Step S3), if necessary based on the result of the forecast calculation.

Next, an elapse of a predetermined forecast time duration is waited for (Step S4), and, an actually measured demand amount, obtained until the elapse of the predetermined forecast time duration, is compared with the forecast demand amount obtained in Step S1 (Step S5).

Then, according to the comparison result, a coefficient in a calculation formula used in the demand forecast carried out in Step S1 is revised appropriately if necessary (Step S6).

Then, under the condition that the coefficient has been thus revised, a demand forecast calculation is carried out again (Step S1). After that, the above-described processing is repeated in sequence.

In the embodiment of the present invention, the coefficient of the calculation formula for the demand forecast calculation is thus revised based on the comparison between the actual value and the forecast value. Accordingly, it is possible to always obtain a demand forecast with a high accuracy.

Further, since a resource increase/decrease is submitted or proposed (Step S2) or the user's priority order adjustment is submitted or proposed (Step S3), based on the demand forecast result, it is possible to effectively utilize the demand forecast result for the resource management, and thus, it is possible to achieve efficient system operation.

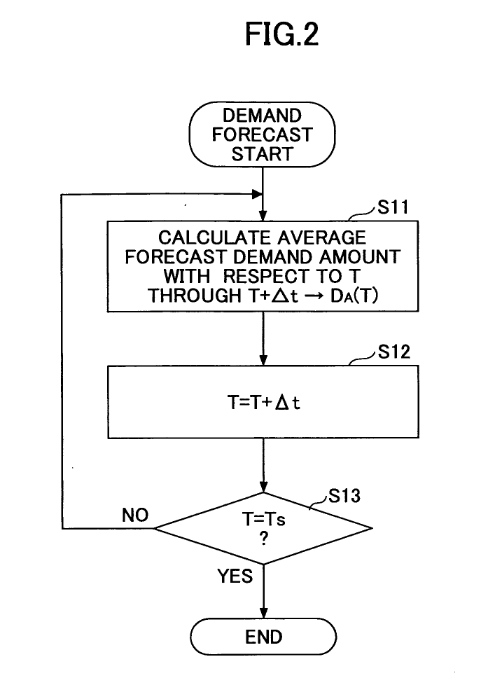

FIG. 2 shows a processing flow chart showing the details of the demand forecast calculation (Step S1) of FIG. 1.

This calculation is based on a well-known Monte Carlo method.

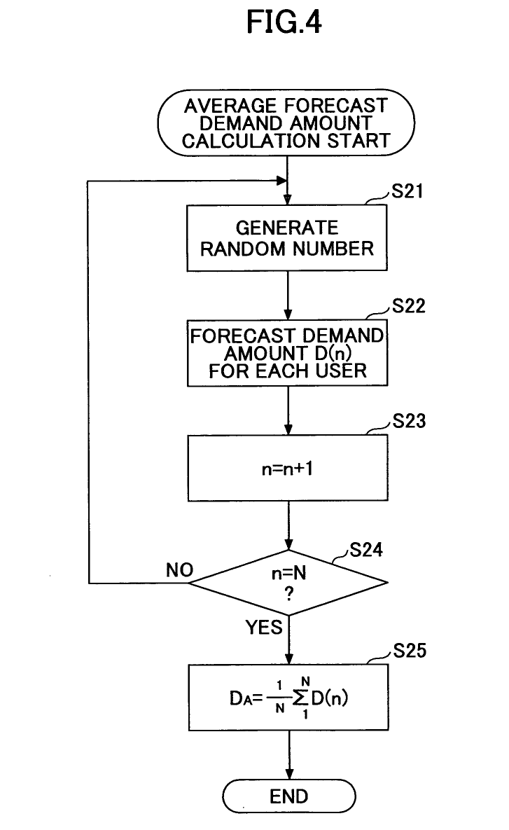

In FIG. 2, an average forecast demand amount D_{A}(T) is calculated with the use of a sequence of random numbers (Step S11, also described later with reference to FIG. 4), and, the calculation is repeated for a predetermined number of times for a predetermined forecast time Ts (n=Ts/Δt) (Steps S12, S13).

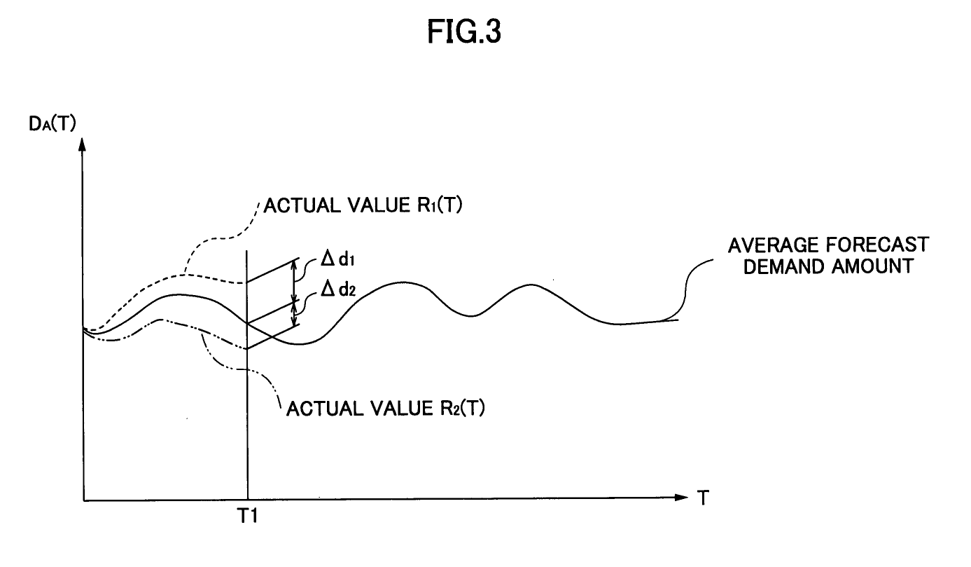

FIG. 3 illustrates the comparison with the actual value (Step S5) of FIG. 1, and shows an example in which a demand forecast obtained from the demand forecast calculation in Step S1 of FIG. 1 is plotted (in a solid line).

In FIG. 3, when the actual value is that indicated in a broken line R₁(T) after the elapse of the predetermined forecast time duration (Step S4), that is, when a difference between the forecast value and the actual value is +Δd1, the coefficient of the demand forecast calculation formula is increased for example (Step S6).

In contrast thereto, when the actual value is that indicated in a chain double dashed line R₂(T) after the elapse of the predetermined forecast time duration (Step S4), that is, when a difference between the forecast value and the actual value is −Δd2, the coefficient of the demand forecast calculation formula is decreased in this example (Step S6).

FIG. 4 shows a processing flow chart showing the details of the ‘average forecast demand amount D_{A}(T) calculation’ in FIG. 2.

As shown in FIG. 4, in the calculation, first a random number is generated (Step S21), and, based on the thus-obtained random number, a forecast demand amount D(n) for a single user is obtained (Step S22). Then, this processing is repeated for the number of users, i.e., N times (Steps S23, S24).

The thus-obtained forecast demand amounts for the N persons are then averaged (Step S25).

It is noted that, as a means for obtaining the random numbers, a well-known device may be applied. For example, a random number function ‘RAND ( )’ in Microsoft Excel, a well-known table calculating application, may be applied.

Below, the embodiment of the present invention based on the above-described basic concept will be described in detail.

In the ‘method of demand forecast and resource management based thereon’ in the embodiment of the present invention, it is directed that, in addition to information processing resources (i.e., CPUs, storage devices such as memories, magnetic disk drives and so forth, communication networks and so forth) required for a large-scale information processing such as CAD (Computer aided design), CAE (Computer aided engineering) or such, large-scale processing resources required for CAD/CAE application software processing, should be efficiently shared.

Then, according to the embodiment of the present invention, it is directed that, the information processing resources are modeled and systematized, resource utilization forecast is calculated for several minutes through several months based on resource utilization experience obtained until now, the entire resources utilization is optimized, and thus, large-scale information processing resource management is achieved at low cost.

Speaking in more details, according to the ‘method of demand forecast and resource management based thereon’ in the embodiment of the present invention, it is directed to, to provide a system for achieving control for making processing resource management more efficient and control for forecasting the demand, for achieving improved high-speed concentrated processing in a large-scale machine center of the ASP center or such, a wide area parallel associating processing with servers/clients scattered to a plurality of bases, and a high speed processing of huge data processing thus scattered to the many bases in the machine environment, at high speed and low cost.

Further, according to the embodiment of the present invention, utilization forecast for several minutes through several months future is obtained based on a predetermined initial value and a current actual value. That is, a modified Monte Carlo simulation system such that, in addition to a calculation processing according to a simple Monte Carlo type optimum solution search manner in the prior art, parameters or calculation coefficients are dynamically revised.

That is, according to the embodiment of the present invention, first, based on users' processing resource demand requests, a resource utilization forecast is carried out based on the resource management definition data in the ASP center and the past utilization experience data, in the above-mentioned modified Monte Carlo simulation system.

That is, with understanding utilization experience or utilization tendency (increasing intensity: +/−/≈) for each person/group, and therewith, the initial value of the random function is modified. Then, for the required number of persons, utilizations are forecast by a simulation according to a parallel Monte Carlo method, and, a required amount of processing resources to provide is thus calculated.

In this case, since the latest resource utilization situation is thus considered, it is possible to achieve an efficient and economical resource management unless an unexpected sharp variation occurs.

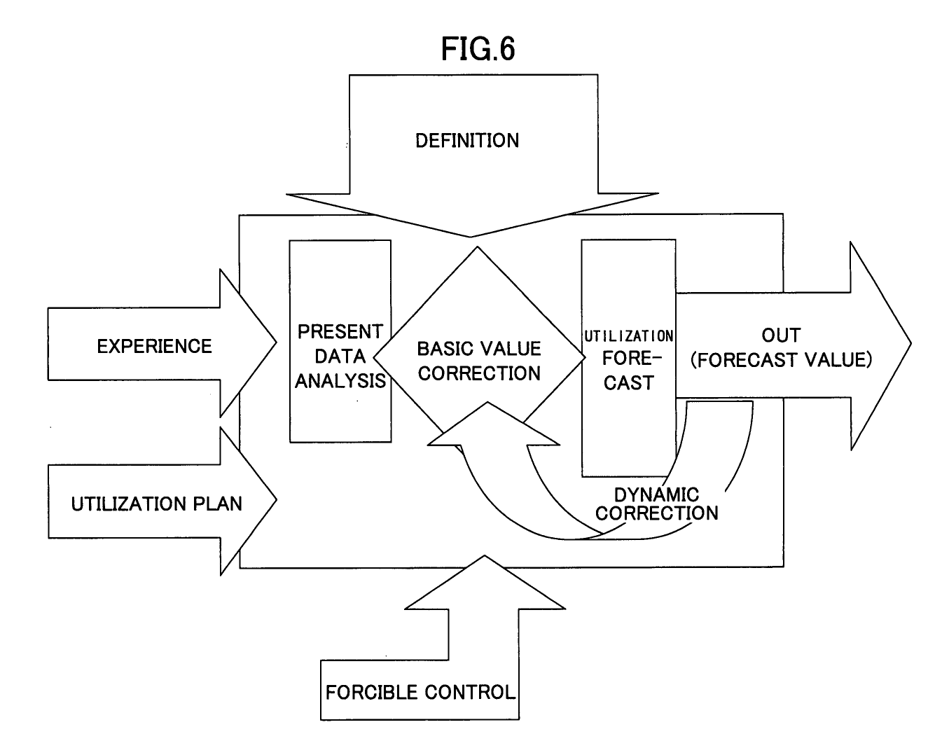

FIG. 6 shows a general configuration of the modified Monte Carlo simulation system in the embodiment of the present invention.

In FIG. 6, respective terms are described as follows:

Definition: definition data based on the users' resources utilization plan information/the center possessing resource information;

Present data analysis: analyses for obtaining a further utilization tendency based on the past utilization experience;

Basic value correction: a forecast value revising parameter involving actual value information into an initial value (initial parameter) of the random function used in the Monte Carlo method;

Utilization forecast: a utilization transition forecast in various condition settings based on the past actual value or experience;

Dynamic correction: a correction by means of repetitive revisions based on a comparison result between the actual value and the forecast value;

Forcible control: a control of operation enlivenment according to the users' needs, based on the users' selection of processing execution conditions

In FIG. 6, the present data analysis is carried out based on the past experience and the future utilization plan obtained from the definition data, and the future utilization forecast (demand forecast) is carried out. At this time, the dynamic correction of a coefficient in a calculation formula of the Monte Carlo method is carried out based on a comparison result between the forecast value and the actual value. Further, the forcible control from the users' selection is also allowed.

That is, according to the present embodiment, based on the CPU utilization experience, disk utilization experience, software license vacant state, and so forth, an initial parameter ‘Sin t’ is determined, a random number is generated, the data for the number of persons (N) is accumulated, the accumulation result is divided by the number of persons among whom the resources are shared, i.e., N, and the thus-obtained value is used as an initial forecast value (according to the formula (1) below). Then, this calculation is repeated for predetermined forecast time duration so that it is possible to obtain a transition for a predetermined forecast time duration (corresponding to Step S1 of FIG. 1; and also, see FIG. 3).

The thus-obtained initial forecast value (transition data) is compared with an actual value, and the difference therebetween is referred to as ‘Δin’. This difference Δin, as well as other necessary seasonally appearing variation tendency factor or such (Pα), are considered, and thus, the forecast value is revised (corresponding to Steps S4 through S6 of FIG. 1).

The following formula (1) is an example of the demand forecast calculation formula in this case:

(1/N)ΣnRAND_{—}M(Sin t+Δin)+Pα (1)

There, Σn denotes a summation for the number of persons N; and RAND_M denotes a function of generating random numbers. As this function, as mentioned above, a random function RAND ( ) in Microsoft Excel may be used.

By repeating this demand forecast calculation including the revision is repeated (corresponding to a repetition of Steps S1, S4 through S6 in FIG. 1), it is possible to obtain a more accurate demand forecast.

The method according to the embodiment of the present invention is referred to as the ‘modified Monte Carlo method’ as mentioned above, since, the forecast value obtained from the simple Monte Carlo method in the prior art is revised with the use of the actual value and so forth, as mentioned above.

Further, when it is expected that the demand will increase in future from the thus-obtained demand forecast result, resources (machines, the number of licenses, or such) to be increased accordingly are submitted or proposed (corresponding to Step S2 of FIG. 1). Similarly, when it is expected that the demand will decrease, resources (machines, the number of licenses, or such) to be reduced accordingly are submitted or proposed. A forecast term (time duration) at this time should be such an order that the increase/reduction of the facilities may be available.

Further, when it is expected from the thus-obtained demand forecast result that an optimization may be possible as a result of making a resource management more efficient, selectable conditions to be applied when the processing is executed is submitted or proposed to each user.

For example, a condition in which a utilization price is raised with the priority order for the processing raised, or contrary, a condition in which a utilization price is lowered with the priority order for the processing lowered, and so forth, may be considered. As a result, it is possible to averaging the processing, and thus, it is possible to reduce the total cost.

A forecast term or time duration in this case should be such an order that a real-time response is required.

Thus, according to the present embodiment, in addition to the conventional forecast method (using various parameters), a future tendency is analyzed from a difference between the forecast value and the actual value, and thus, the forecast accuracy is always improved. Accordingly, it is possible to reduce the resource providing cost. Further, by improving the forecast accuracy, it is possible to reduce a time duration for which the users should wait for. Accordingly, user serviceability can be improved.

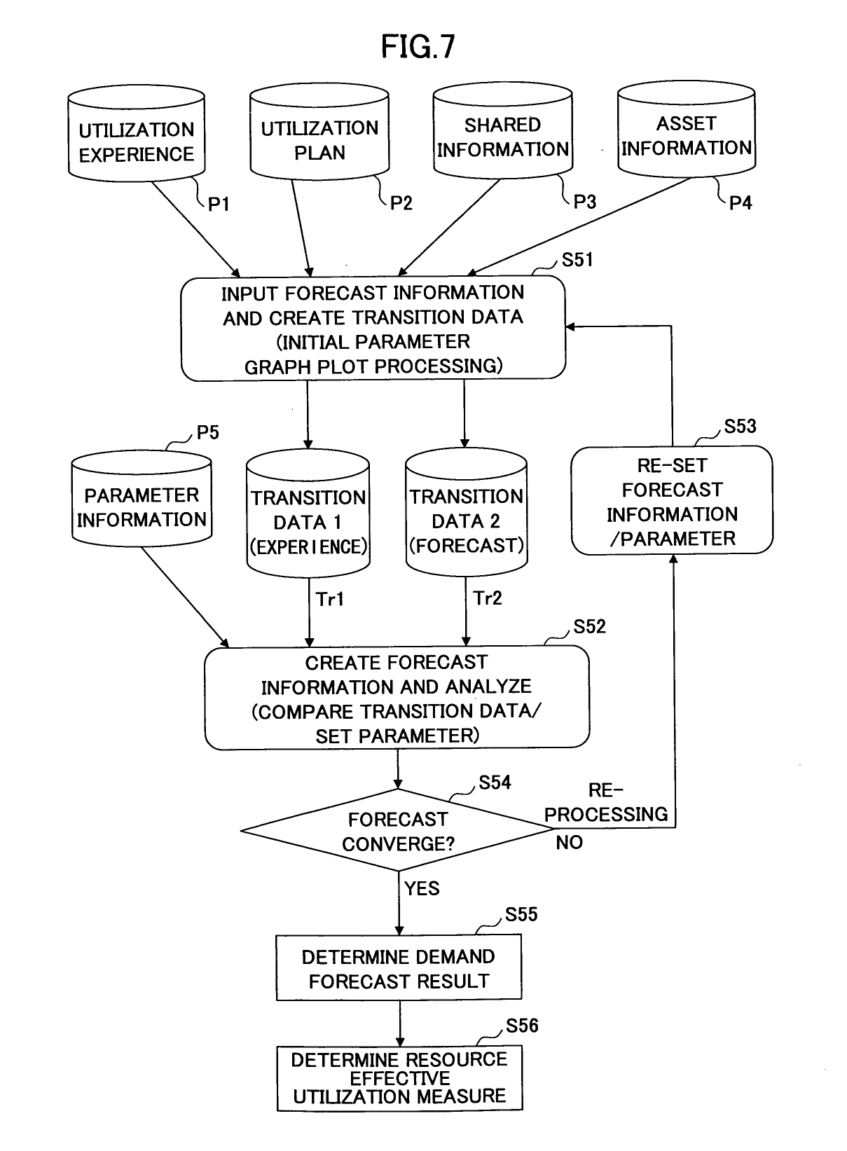

FIG. 7 shows a processing flow chart illustrating a variant embodiment of the above-described embodiment of the present invention.

In this variant embodiment, transition data for a demand forecast is created from repeating calculation of the above-mentioned formula (1) for a predetermined forecast time duration as mentioned above based on various sorts of data P1 through P4 (Step S51), after that, the demand forecast data is analyzed based on predetermined parameter information P5 and on a result of a comparison between the transition data Tr1 of the past experience value and the transition data Tr2 of the forecast value (Step S52).

As a result, it is determined (Step S54) whether or not a convergence is obtained. When no convergence is obtained, a calculation coefficient in the Monte Carlo method is revised appropriately (Step S53).

By repeating the loop of Steps S51, S52, S54 and S53, it is possible to improve the demand forecast accuracy.

The above-mentioned determination in Step S54 as to whether or not a convergence is obtained may be made from a determination as to whether or not the number of times of the repetitions of the above-mentioned loop has reached a predetermined value.

Based on the thus-obtained demand forecast value, resource effective utilization measures are determined (Steps S55, S56).

The contents of the resource effective utilization measures in Step S56 are such as the processing of Steps S210 through S240, Steps S310 through S340, and Steps S410 through S450 of FIG. 8, described later.

FIG. 8 shows a processing flow chart of the ‘method of demand forecast and resource management based thereon’ in the embodiment of the present invention.

An example of a detailed hierarchy structure of resource utilization experience analysis data processed in this method is shown below:

1. utilization experience information:

disk utilization amount

CPU utilization time

IA server run time

2. software license information (utilization tool information):

tool name

FEATURE name (application function name)

version number

term

the number of applications used simultaneously

accompanying information

basic unit price

registered date

person in charge

In FIG. 8, in a forecast data calculating processing (Step S100), the initial parameter ‘Sin t’ in the calculation of the Monte Carlo method is determined.

The initial parameter Sin t is determined, for example, based on data such as the above-mentioned CPU utilization time, disk utilization amount, tool vacant state, and so forth.

Then, from the following formula (1), the above-mentioned initial forecast value is obtained (Step S110).

(1/N)ΣnRAND_{—}M(Sin t+Δin)+Pα (1)

There, Δin denotes a dynamic correction value obtained from a comparison between an actual value and a forecast value, and Pα denotes a correction value by other various factors (a tendency from a seasonal variation, or such).

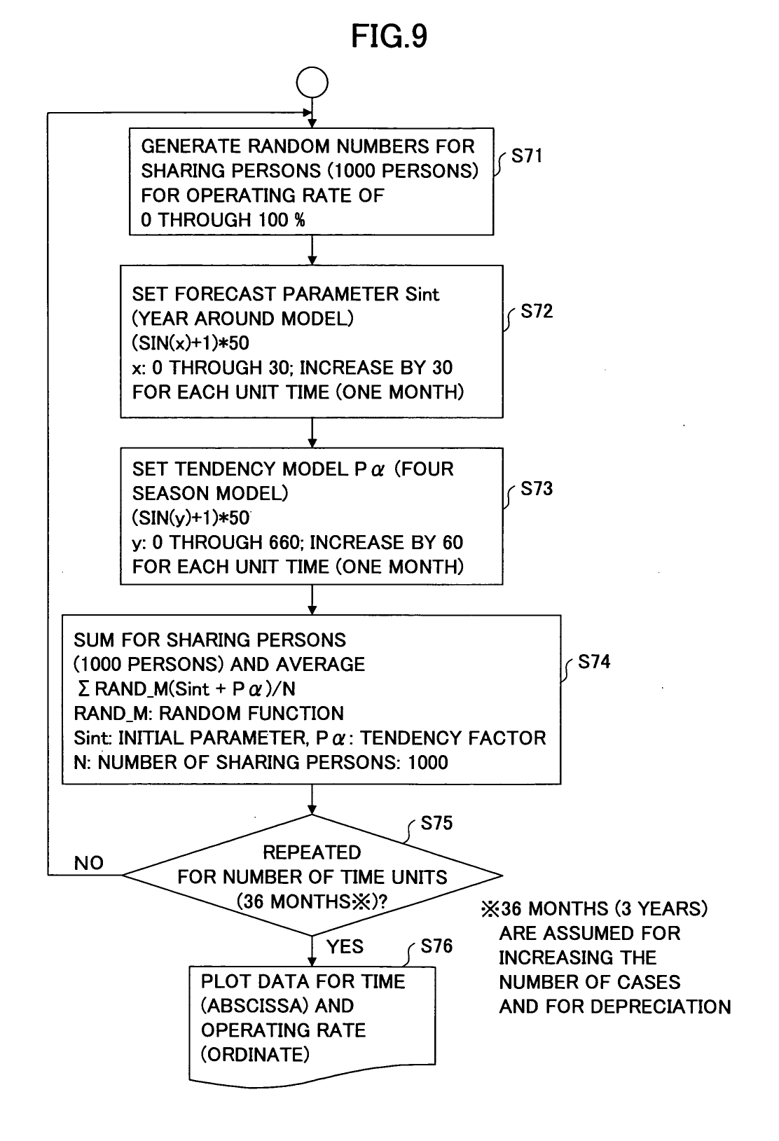

Based on the thus-obtained initial forecast value, a calculation with the above-mentioned formula (1) is repeated for a predetermined forecast time duration, and thus, demand forecast transition data is obtained. In this case, each time of the repetition, the respective coefficients of the formula (1) are appropriately revised. For a specific way of the revision, a method described later with reference to FIG. 9 (i.e., with a sine function) may be applied, for example.

Based on the thus-obtained demand forecast transition data, the processing of Steps S210 through S240, Steps S310 through S340, or Steps S410 through S450, described below, is carried out:

S210: This branch is executed when it is expected that the demand for the resources will increase.

S220: It is determined whether or not an augmentation of the machines, i.e., the hardware resources, is effective.

S230: When the determination result of Step S220 is Yes, a necessary machine augmentation amount is submitted or proposed to the operator.

S240: When the determination result of Step S220 is No, a necessary number of licenses (i.e., software resources) to increase is submitted or proposed to the operator.

It is noted that, the above-mentioned determination result may vary according to the setting of the above-mentioned initial parameter.

S310: This branch is executed when it is expected that the demand for the resources will decrease.

S320: It is determined whether or not a reduction of the machines, i.e., the hardware resources, is effective.

S330: When the determination result of Step S320 is Yes, a necessary machine reduction amount is submitted or proposed to the operator.

S340: When the determination result of Step S320 is No, a necessary number of licenses (i.e., software resources) to reduce is submitted or proposed to the operator.

It is noted that, the above-mentioned determination result may vary according to the setting of the above-mentioned initial parameter.

S410: This branch is executed when it is expected that the resources are in short supply in a real-time manner.

S420: A price list for a job priority order change is submitted to the user.

S430: An inquiry is given to the user as to whether or not the priority order is to be raised.

S440: When the response to S430 is Yes, the job priority order is raised, and the charge amount is corrected accordingly (increased).

S450: When the response to S430 is No, the job priority order is lowered, and the charge amount is corrected accordingly (decreased).

Next, in Step S500, after an elapse of a predetermined time duration, an analysis is made for an error between the forecast value and the actual value. The thus-obtained correction value Δin is substituted in the above-mentioned formula (1), and Step S101 is returned to.

FIG. 9 shows a processing flow chart showing a specific example of the above-mentioned forecast data calculation processing (Step S100).

In FIG. 9, first, the number of random numbers are generated for the corresponding number of users (N), respectively (Step S71).

Next, the initial parameter Sin t is set (Step S72), and the tendency factor Pα is set (Step S73).

It is noted that, in each of Steps S72 and S73, SIN denotes a sine function, ‘sin’.

Next, based on the thus-obtained forecast parameter and the tendency factor, a random number obtained in Step S71 is applied for each user, and thus, a forecast demand amount is obtained for each user, and, further, an average thereof (i.e., average forecast demand amount) is obtained (Step S74).

Then, the processing of Steps S71 through S74 is repeated for the predetermined forecast time duration (Step S75).

In this example, the unit time is determined in one month, and thus, the required number of repetition times is 36 (i.e., three years).

Then, the thus-obtained average forecast demand amounts for the 36 months are plotted (Step S76).

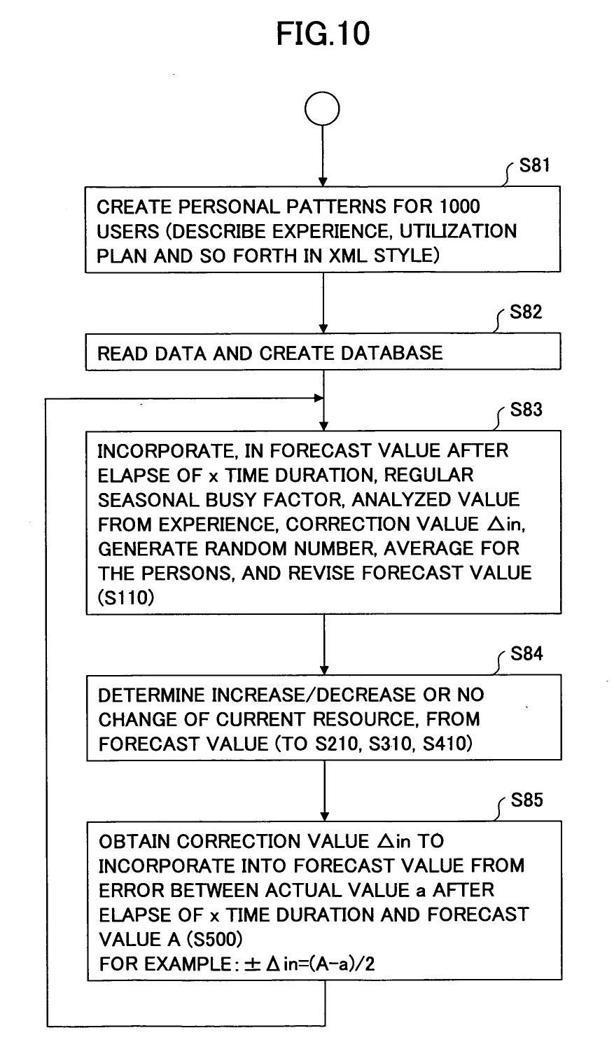

FIG. 10 shows a flow chart illustrating the revision processing with the actual values according to the present embodiment.

In FIG. 10, the initial pattern Sin t is obtained for the number of users (Step S81), and corresponding database is created therewith (Step S82).

In Step S83, in the above-mentioned formula (1), the initial pattern Sin t thus created in the database, the correction value Δin obtained from the difference (A−a) from the actual value obtained after the elapse of the predetermined time duration (x hours) obtained in Step S85, and the other seasonal busy factor and tendency factor Pα obtained from the analysis of the past experience, are substituted, and thus, the forecast demand amount is obtained for each user. Then, further the average among the users (i.e., the average forecast demand amount) is then obtained, and after that, the calculation of the formula (1) is repeated until the forecast time duration has reached the predetermined time duration in a way similar to the above, and thus, the transition data of the average forecast demand amount is obtained (Step S83).

Based on the thus-obtained average forecast demand amount transition data, the resource increase/decrease may be submitted or proposed, the priority order adjustment is submitted or proposed, or such, as described above with reference to FIG. 8 (Step S84).

Next, after the elapse of the predetermined forecast time duration, the forecast value and the actual value are compared with each other (Step S85). Then, the comparison result and so forth are considered as described above, the specific values of the coefficients in the formula (1) are appropriately revised, and, the average forecast amount is calculated again (Step S83).

The processing of Steps S83 through S85 is repeated thereafter.

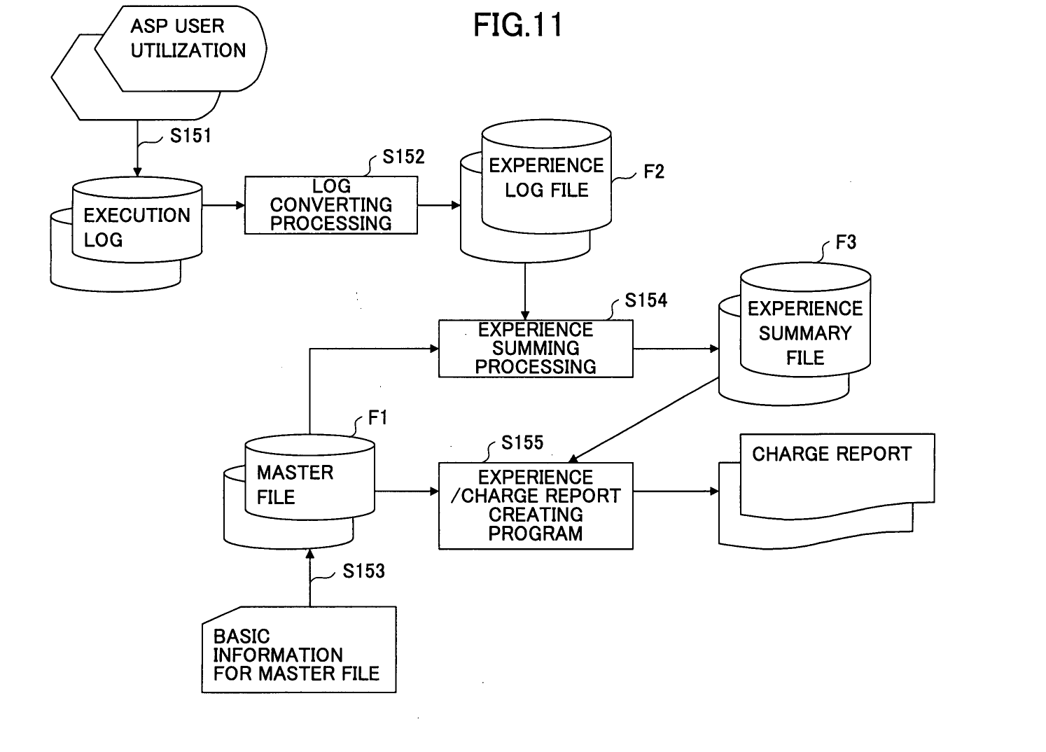

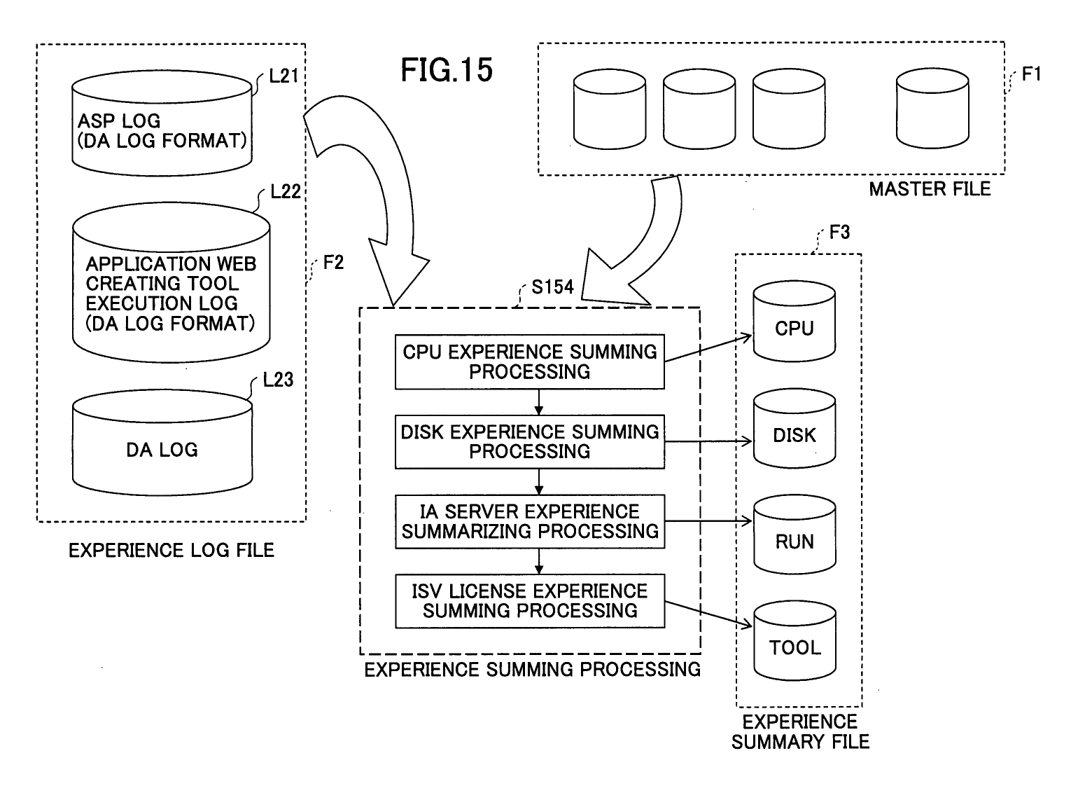

Next, with reference to FIGS. 11 through 15, a specific example of operation of an ASP to which the embodiment of the present invention is applicable, is described.

In FIG. 11, user's service utilization experience is stored in an execution log each time, (Step S151), the contents of the log undergoes predetermined data conversion (Step S152), and then, are stored in an experience log file F2.

On the other hand, based on the contents of a master file F1 described later, the experience data stored in the experience log file F2 is summed (Step S154), and the summary result is stored in an experience summary file F3.

Then, based on the contents of the master file F1, the experience summary data stored in the experience summary file F3 is applied, and a corresponding charge report is created for each user (Step S155).

Specific registration contents in the above-mentioned master file F1 are as follows:

Charge information: [disk, CPU, IA run time] basic/specific unit price, [CPU, IA] reference machine performance factor/reference name;

FEATURE information (application function): tool name/version number, FEATURE name, due date, available number, basic/specific unit price, registration date, person in charge;

Resource application information: requester's name, requester's division name, division code, category, machine type, registration date, person in charge, required amount (per month);

Center server information: IP address, host name, category, machine type name, unit price factor, CPU type, performance factor, valid date, registration date, person in charge, machine type identification name;

Tool information: resource ID, vendor daemon name, providing condition, tool name, tool version number, contract number, registration date, person in charge, license period, purchase cost, maintenance cost, depreciation for this year, operation environment, function classification code, function summary, valid period (start/end), only license utilization application flag;

User machine information: requester's name, division name, group to be charged, IP address, machine setting location, utilization period, condition, allowed date, registration date, person in charge, requester's ID name, group name, tool name list; and

Tool request information: requester's name, division name, division code, tool name, version number, category, registration date, person in charge, required number (per month)

Next, a specific example of the record contents of the above-mentioned experience log file F2 is as follows:

ASP log: start date/time, finish date/time, system name, function name, version number, execution host name, login name, process ID, execution time, OS version number, IP address, the number of licenses, extension information; and

‘Application Web creating tool’ log: ASP account name, function name, execution start date/time, execution time, execution host name

Next, a specific example of the storage contents of the experience summary file F3 is as follows:

CPU utilization experience: year, month, ASP account, IP address, CPU time, CPU performance factor, the number of execution times;

Disk utilization experience: year, month, ASP group name, disk utilization amount;

Host utilization experience: year, month, category (center/user host), IP address, host name, execution time, the number of execution times;

Execution experience: year, month, user name (account), ASP group name, tool name, FEATURE name, IP address, host category, execution time, the number of execution times, UNIX/PC identification; and

License utilization experience: year, month, internal serial number, tool name, FEATURE name, the maximum number of simultaneously available licenses, host category, UNIX/PC identification (UNIX: registered trade mark)

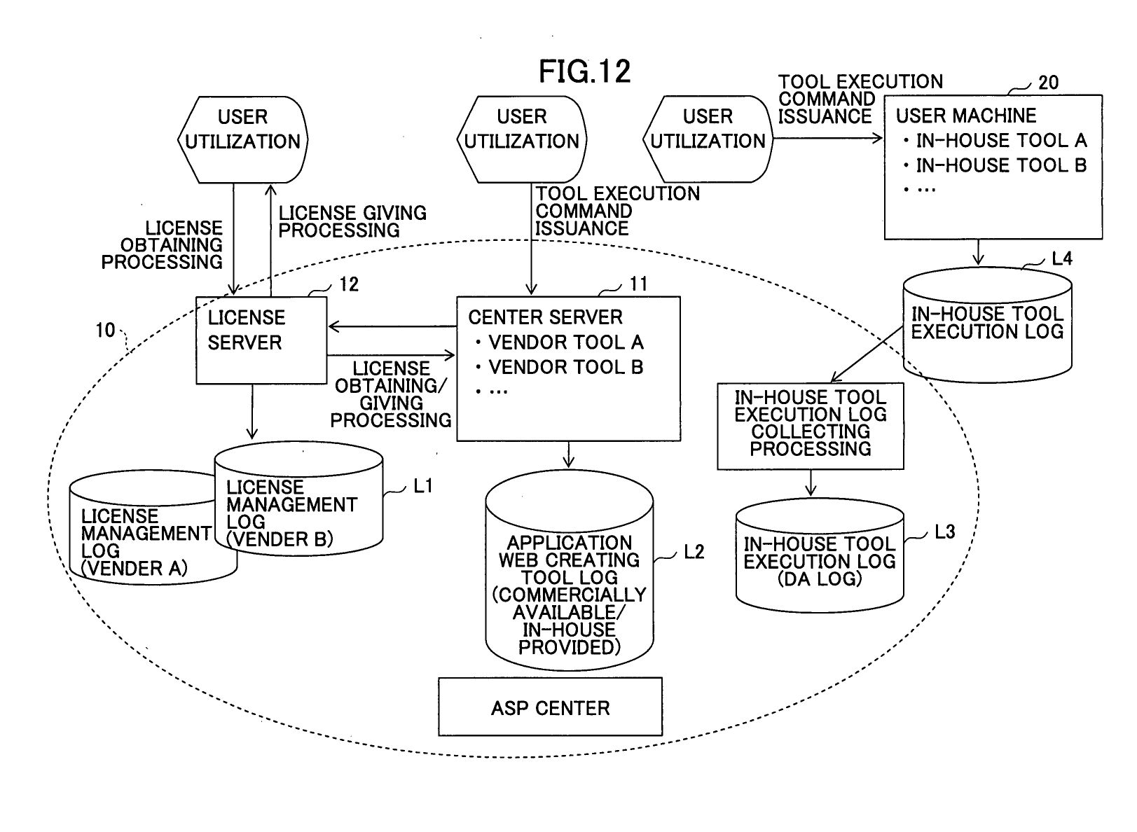

FIG. 12 illustrates details of Step S151 of FIG. 11.

It is noted that, the resource utilization plan is previously requested by each user, and experience information for the actual utilization is summed by the following processing:

The user logins to an ASP center 10. Then, for example, when a CAD tool is used, the CAD tool is used via a center server 11 based on a license previously obtained and registered in a licensee server 12.

Then, an execution log of the usage experience is recorded in a predetermined storage device in the ASP center 10.

In this example, the license previously obtained is registered in the license management log L1 via a license server 12.

Further, when the user requests the utilization of a tool from the center server 11, a corresponding execution log is recorded in an application Web creating tool log L2.

Or, when the user wishes to utilizes a tool on an in-house user machine 20, a corresponding execution-log is recorded once in an in-house tool execution log L4, and the contents are then transferred to the ASP center 10, and then, are recorded in an in-house execution log L3 thereof.

Log recording to the license management log L1, from among these log files L1, L2 and L3, is carried out when the user logins to the license server 12 and obtains a tool license and, execution of the tool is carried out with the user machine 20.

Further, log recording to the ‘application Web creating tool’ log L2 is carried out when the user logins to an apparatus of the ASP center 10, and executes a tool previously installed therein. The application Web creating tool is a tool for using an ISV tool from a Web.

Other than these, the ASP center 10 has a plurality of execution logs such as a DA log L3 (in-house tool execution log), an in-house ‘CAD application Web creating tool’ log, and so forth.

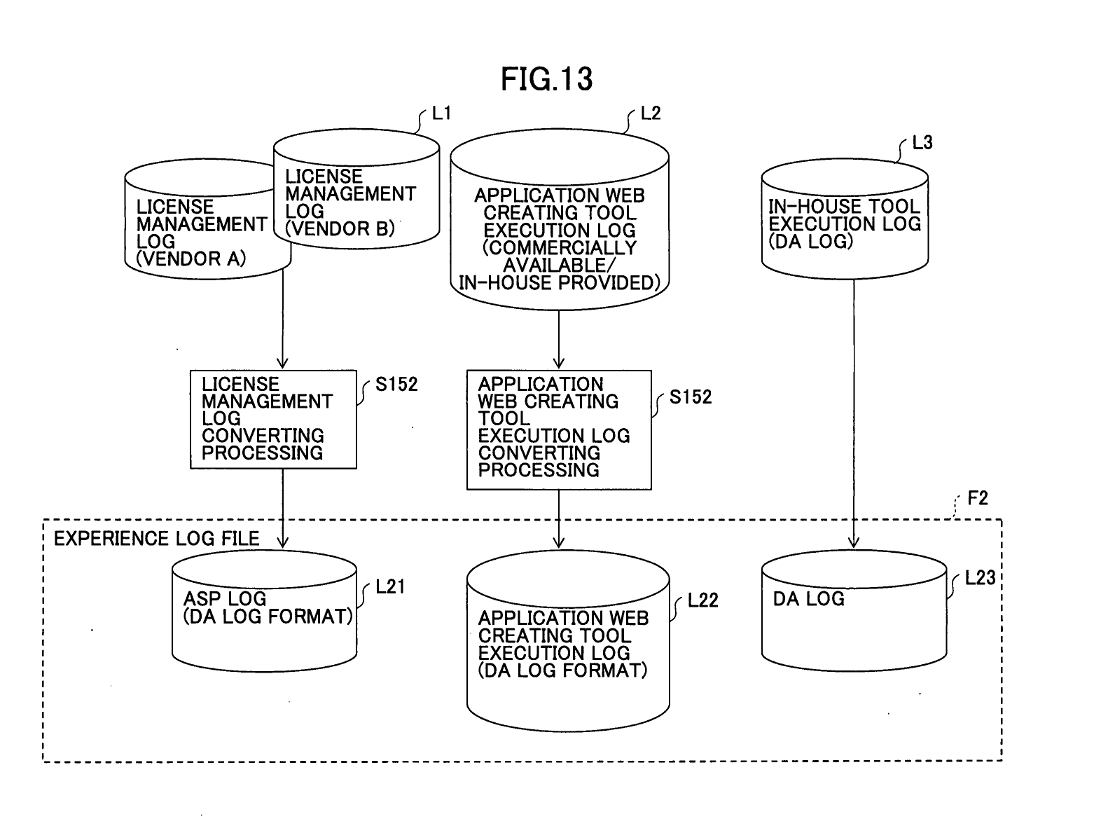

Data recording formats recorded in these execution logs may differ from each other (a binary format, . . . ) depending on corresponding tools which carry out the recording operation, and thus, as shown in FIG. 13, each thereof is once collected separately, necessary information is extracted therefrom, the thus-obtained necessary information is re-configured, and thus, is converted in a common format log (Step S152). In this case, each log format is converted into a DA log format (L22, L23) for example.

Further, the license management log L1, output for each particular vendor, is collected into one, is converted into the DA log format in an ASP log L21, and thus is output (Step S152).

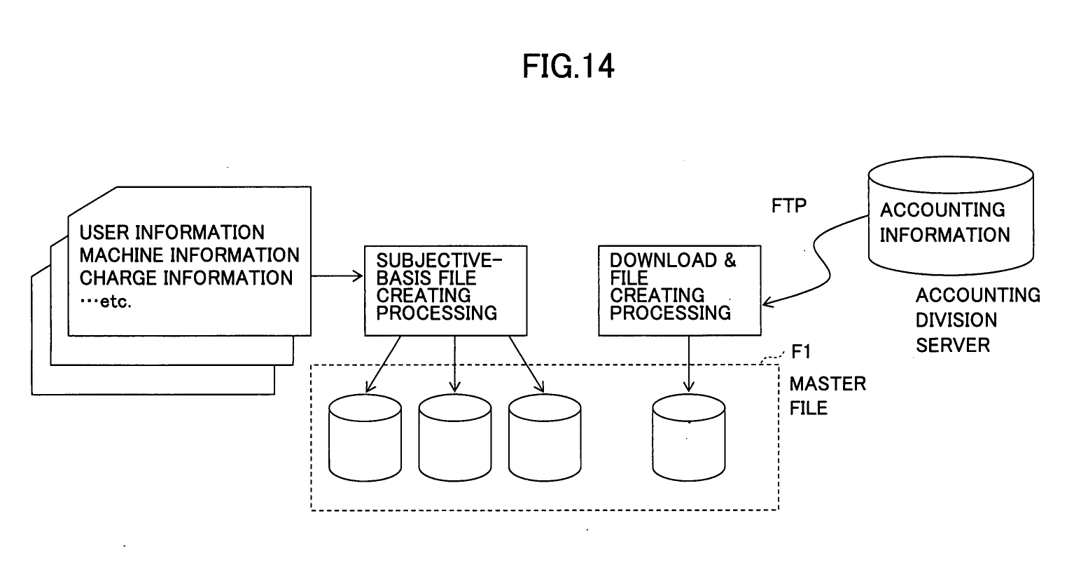

In Step S153 of FIG. 11, files recording basic data such as the user information, machine information, charge information and so forth, are read, and is converted into a format to be utilized for the experience summing processing, charge information creating processing or such, and thus, the master file F1 is generated, as shown in FIG. 14.

In Step S154 of FIG. 11, the execution log file F2 recording the CPU execution start time, finish time, tool's FEATURE (application's function) name and so forth, and the master log file F1 recording the tool's FEATURE name definition, user's affiliation, serial number, login name, and so forth, are read, the experience summing processing is carried out, and the experience summary files F3 (the CPU usage experience, disk usage experience, tool usage experience and so forth) are output.

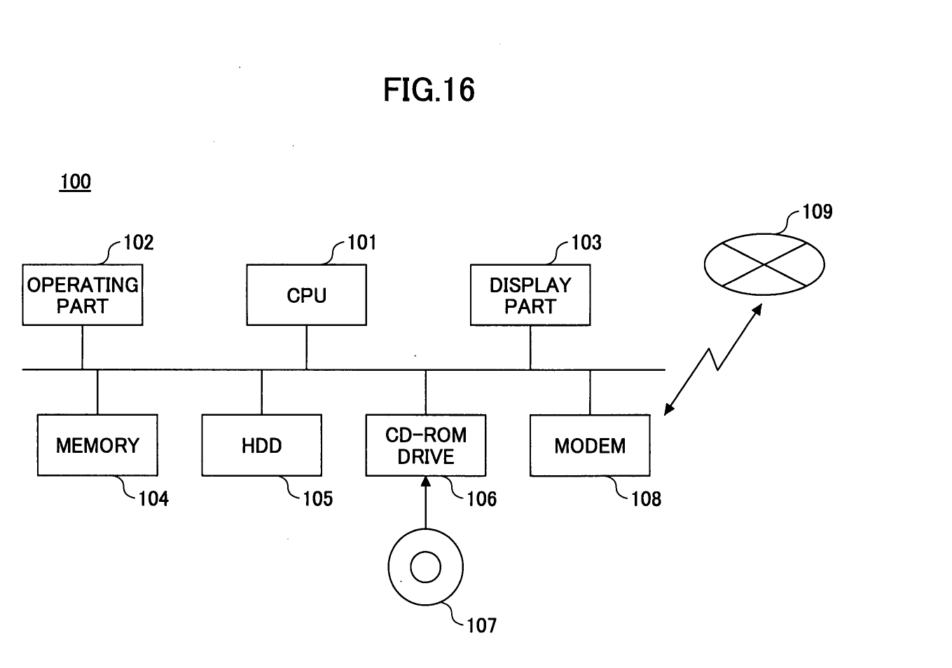

FIG. 16 shows a block diagram of a computer for illustrating a case where the method of demand forecast and resource management based thereon in the embodiment of the present invention is automatically implemented by the computer.

As shown in FIG. 16, the computer 100 includes a CPU 101 for carrying out various operations by executing instructions written in a given program; an operating part 102 such as a keyboard, a mouse, and so forth, for a user to input operation contents or data; a display part 103 such as a CRT, a liquid crystal display device or such, for displaying, to the user, a processing progress, a processing result or such of the CPU 101; a memory 104 such as a ROM, a RAM and so forth, for storing the program to be executed by the CPU 101 or to be used as a work area of the CPU 101, a hard disk drive 105 for storing the program, data and so forth; a CD-ROM drive 106 for loading the program or data from the outside with the use of a CD-ROM 107 as a portable information recording medium; and a modem 108 for downloading the program or such, from an external server via a communication network 109 such as the Intent, LAN or such.

The computer 100 loads or downloads the program having the instructions for causing the CPU 101 to implement the above-mentioned method of demand forecast and resource management based thereon described above with reference to FIGS. 1 through 4. The CD-ROM 107 may be used as an information recording media or the communication network 109 may be used for, thus loading or downloading the program. The program is then installed in the hard disk drive 105, is loaded on the memory 104, and is executed by the CPU 101, appropriately. As a result, the computer 100 implements the above-mentioned method of demand forecast and resource management based thereon.

Thus, in this case, the computer 100 acts as the information processing apparatus in the embodiment of the present invention.

It is noted that the contents of the resources possessed by the ASP for which the demand is forecast in the embodiment of the present invention may be applied, may be considered as the CPU processing performance, storage capacities of the disk devices and so forth, the number of licenses of the software resources and/or the data transmission capabilities of data transmission channels, for example.

The present invention is not limited to the above-described embodiment, and variations and modifications may be made without departing from the basic concept of the present invention claimed below.

The present application is based on Japanese Priority Application No. 2006-196083, filed on Jul. 18, 2006, the entire contents of which are hereby incorporated herein by reference.

What is claimed is:

1. An information processing method for a system providing a service in response to a request, comprising:
a demand forecasting step of forecasting a demand by means of a calculation according to a Monte Carlo method;
an actual value comparing step of comparing the forecast value obtained from said demand forecasting step with an actual value to obtain a difference therebetween; and
a coefficient revising step of revising a calculation coefficient used in said demand forecasting step in consideration of the difference.

2. The information processing method as claimed in claim 1, further comprising:
a resource increase/decrease submitting step of submitting an increase/decrease of a resource which the system has, based on the forecast value obtained from said demand forecasting step.

3. The information processing method as claimed in claim 1, comprising:
a request responding condition revising step of submitting a revision of a condition for responding to a request, based on the forecast result obtained from said demand forecasting step.

4. The information processing method as claimed in claim 1, wherein:
in said demand forecasting step, the calculation coefficient to use is determined in consideration of at least any one of a utilization experience of a CPU the system has; a utilization amount of a storage device the system has; the number of currently used licenses for software resources the system has; and the number of currently used communication lines the system has.

5. The information processing method as claimed in claim 1, wherein:
said demand forecasting step comprises:
a random number generating step of generating a random number for each one of users;
a forecast demand amount obtaining step of obtaining a forecast demand amount for each user based on the random number obtained in said random number generating step; and
an average demand amount obtaining step of obtaining an average forecast demand amount by averaging the forecast demand amounts for the respective users obtained from said forecast demand obtaining step, and wherein:
said random number generating step, said forecast demand amount obtaining step and said average demand amount obtaining step are repeated for a predetermined forecast time duration, and thus, a demand forecast for said predetermined forecast time duration is obtained.

6. An information processing apparatus for a system providing a service in response to a request, comprising:
a demand forecasting part forecasting a demand by means of a calculation according to a Monte Carlo method;
an actual value comparing part comparing the forecast value obtained from said demand forecasting part with an actual value, to obtain a difference therebetween; and
a coefficient revising part revising a calculation coefficient used in said demand forecasting part, in consideration of said difference.

7. The information processing apparatus as claimed in claim 6, further comprising:
a resource increase/decrease submitting part submitting an increase/decrease of a resource which the system has, based on the forecast value obtained from said demand forecasting part.

8. The information processing apparatus as claimed in claim 6, comprising:
a request responding condition revising part submitting a revision of a condition for responding to a request, based on the forecast result of said demand forecasting part.

9. The information processing apparatus as claimed in claim 6, wherein:
said demand forecasting part determines the calculation coefficient to use in consideration of at least any one of a utilization experience of a CPU the system has; a utilization amount of a storage device the system has; the number of currently used licenses for software resources the system has; and the number of currently used communication lines the system has.

10. The information processing apparatus as claimed in claim 6, wherein:
said demand forecasting part comprises:
a random number generating part generating a random number for each one of users;
a forecast demand amount obtaining part obtaining a forecast demand amount for each user based on the random number generated by said random number generating part; and
an average demand amount obtaining part obtaining an average forecast demand amount by averaging the forecast demand amounts for the respective users obtained by said forecast demand obtaining part, and wherein:
generation of random numbers by said random number generating part, obtaining of the forecast demand amounts for the respective users by said forecast demand amount obtaining part and obtaining of the average demand amount by said average demand amount obtaining part are repeated for a predetermined forecast time duration, and thus, a demand forecast for said predetermined forecast time duration is obtained.

11. A program used for a system providing a service in response to a request, comprising instructions to cause a computer to carry out:
a demand forecasting step of forecasting a demand by means of a calculation according to a Monte Carlo method;
an actual value comparing step of comparing the forecast value obtained from said demand forecasting step with an actual value to obtain a difference therebetween; and
a coefficient revising step of revising a calculation coefficient used in said demand forecasting step in consideration of the difference.

12. The program as claimed in claim 11, further comprising instructions to cause the computer to carry out:
a resource increase/decrease submitting step of submitting an increase/decrease of a resource which the system has based on the forecast value obtained from said demand forecasting step.

13. The program as claimed in claim 11, comprising instructions to cause the computer to carry out:
a request responding condition revising step of submitting a revision of a condition for responding to a request, based on the forecast result obtained from said demand forecasting step.

14. The program as claimed in claim 11, wherein:
in said demand forecasting step, the calculation coefficient to use is determined in consideration of at least any one of a utilization experience of a CPU the system has; a utilization amount of a storage device the system has; the number of currently used licenses for software resources the system has; and the number of currently used communication lines the system has.

15. The program as claimed in claim 11, wherein:
said demand forecasting step comprises:
a random number generating step of generating a random number for each one of users;
a forecast demand amount obtaining step of obtaining a forecast demand amount for each user based on the random number obtained from said random number generating step; and
an average demand amount obtaining step of obtaining an average forecast demand amount by averaging the forecast demand amounts for the respective users obtained from said forecast demand obtaining step, and wherein:
said random number generating step, said forecast demand amount obtaining step and said average demand amount obtaining step are repeated for a predetermined forecast time duration, and thus, a demand forecast for said predetermined forecast time duration is obtained.
